(19) United States
(12) Patent Application Publication
(10) Pub. No.: US 2002/0011393 A1
(43) Pub. Date: Jan. 31, 2002

(54) Currency receiving device and method

(75) Inventor: John Siemens, Kleinberg (CA)

Correspondence Address: PIASETZKI & NENNIGER, Suite 2308, 120 Adelaide Street West, Toronto, ON, M5H 1T1, CA

(73) Assignee: NAMSYS INC.

(21) Appl. No.: 09/729,285

(22) Filed: Dec. 5, 2000

(30) Foreign Application Priority Data
Jul. 28, 2000 (CA) 2,314,719

(51) Int. Cl. G06M 1/02; G06M 3/00

(52) U.S. Cl. 194/215; 194/350

(57) ABSTRACT

A currency receiving device for receiving currency from a user, comprising a body adapted to be moved by a person, a currency input controller, attached to the body, to receive and count deposits of currency, a currency receptacle, operatively connected to the currency input controller, to receive currency from the currency input controller and to store the currency, and a source of power, to provide power to the currency input controller, wherein, upon receiving a first deposit of currency at a first location, the currency receiving device may be moved to a second location to receive a second deposit of currency at the second location.

### FIELD OF THE INVENTION

This invention relates to the general field of currency handling equipment, and more particularly to devices capable of accepting deposits of paper currency.

### BACKGROUND OF THE INVENTION

The use of currency in the form of paper bills and metal coins remains a fixture of the modern commercial world. While a large portion of commercial transactions make use of non-currency financial instruments such as credit cards, debit cards, checks and the like, the continued extensive use of currency seems assured. The favourable characteristics of currency include convenience, especially for smaller transactions, and anonymity of purchase.

However, these advantages for consumers can also give rise to problems relating to security and financial integration for businesses that function in high cash environments, such as supermarkets and other large retail outlets. It is common in these stores to have a large number of checkout counters or cash registers, each of which can accumulate a substantial amount of cash in the course of a business day. At some point it is necessary to collect the cash from the various cash registers and transport it safely to a bank, where it can be credited to the store's account.

A common practice is for bonded and armed security personnel or guards to arrive in an armoured truck. The guards usually carry with them a number of empty bags and proceed sequentially to each of the registers in the store. The bags are often made from a heavy canvas material, and do not otherwise have any particular security features. At each register the clerk removes the cash and deposits it in an empty bag. A notation is made or receipt issued to establish that the contents of a specific bag have been received from a particular register, attended by a particular clerk. The receipt is used for later confirmation of the deposit. Each cash register also keeps an electronic record of the cash received. A printout of this “cash-in-till” figure may be produced and placed in the deposit bag and/or the cash register. The bags are then delivered to a bank or central repository, where their contents are counted. The “prime count”, or first count of each bag, is compared to the “cash-in-till” figure to confirm accuracy. If there is a discrepancy, the authorities are alerted and the matter is investigated. Finally, the confirmed cash figure is credited to the store's account.

A disadvantage of the above is the delay between the time the clerk releases the cash and the time the cash is counted and confirmed. Even though the cash in transit is subject to stringent security measures, since it has a significant value and is usually only carried in canvas bags there will always be some risk of loss through theft or pilferage. The clerk's integrity is at risk during this time, since the cash was released without first obtaining a meaningful receipt. The store's finances are also affected by the delay since during this period, which can take several days, the cash is not available to fund operations or collect interest. Therefore, in contrast to modern electronic payment means such as credit or debit cards, cash is relatively awkward to collect and record, and is not as efficiently integrated into corporate financial systems.

In an alternative cash-collection approach, the cash register clerk or other store employee may transfer the cash from a register to a secure safe located elsewhere in the store. In that case, the cash from each register would still have to be kept in its own bag, or counted before deposit. The guards who arrive to retrieve the cash would now only have to make the one collection from the store safe. A further advantage is conferred by use of the currency receiving device taught in U.S. Pat. 5,538,122, which includes a safe with an attached currency counter. Cash is deposited in an input bin, counted, and upon acceptance by the user transferred through a retractable slot to a removable receptacle within the safe. Accordingly, this device reduces the risk of an inaccurate count by the employee. Further, security is enhanced since the main access door to the safe remains locked until accessed by the guards to remove the cash receptacle.

However, this approach suffers from the various risks created by having regular employees transport cash within the store. The cash being carried to the safe could be dropped and lost, misplaced, pilfered, or possibly attract the attention of professional thieves emboldened by the absence of proper security. Further, the approach does not address the matter of the unavailability of the cash prior to its deposit in the bank.

In the absence of any meaningful solution to these problems, the retrieval and deposit of cash gathered in a high cash environment may continue to be a costly and risky proposition.

### SUMMARY OF THE INVENTION

What is required is a currency receiving device and method which overcomes the problems associated with the current devices and methods used for cash collection.

Most particularly, the device and method should allow the user operating a cash register to make a secure and efficient deposit in as convenient a manner as possible. This is preferably achieved by enabling the user to make the deposit without leaving his or her cash register station. In this way, the user would not have to transport the cash or otherwise be placed in a position which compromises the user's personal security. Similarly, the user would not be compelled to take on a responsibility for cash security away from the station for which he or she has not been trained. It would also be advantageous if the device could count the cash being deposited and provide a record of the count, so that the user will be informed from the outset as to the amount of cash being attributed to the user's register. In this way, any intervening loss of cash will be properly identified as arising from some other source. Further, the device should allow the user to retrieve the cash after it is counted but before it is deposited, if desired. The user could then re-check the cash in cases where the count does not match the cash-in-till or the user's prior expectation.

To receive cash deposits from multiple user stations, it would be advantageous for the device to be readily mobile, particularly in high cash environments such as supermarkets or large retail stores. Preferably, the device could be moved by one person. In this way the device could be operated by a single guard, permitting the guard's partner, if any, the freedom to devote all of his or her attention to security surveillance. At the same time, the device should preferably provide a secure storage enclosure that prevents unauthorized removal of the cash contents, while providing convenient and secure access for authorized removal. Yet another desirable feature would be for the device to be able to communicate the cash count to an associated financial office such as the store's bank or central computer, so that the deposited cash could be utilized as expeditiously as possible.

Accordingly, there is provided a currency receiving device for receiving currency from a user, comprising:

a body adapted to be moved by a person;

a currency input controller, attached to the body, to receive and count deposits of currency;

a currency receptacle, operatively connected to the currency input controller, to receive currency from the currency input controller and to store said currency; and

a source of power, to provide power to said currency input controller;

wherein, upon receiving a first deposit of currency at a first location, said currency receiving device may be moved to a second location to receive a second deposit of currency at said second location.

### BRIEF DESCRIPTION OF THE DRAWINGS

Reference will now be made, by way of example only, to preferred embodiments of the invention as illustrated in the attached figures.

FIG. 1 is a perspective view of the currency receiving device of the present invention;

FIG. 2 is a perspective view of the currency receiving device of FIG. 1 from another side, showing the front door open and the canister and battery exposed;

FIG. 3 is a perspective view of the canister of FIG. 2; and

FIG. 4 is a perspective view of the interior space of the lower front section of the currency receiving device of FIG. 1.

### DETAILED DESCRIPTION OF THE PREFERRED EMBODIMENTS

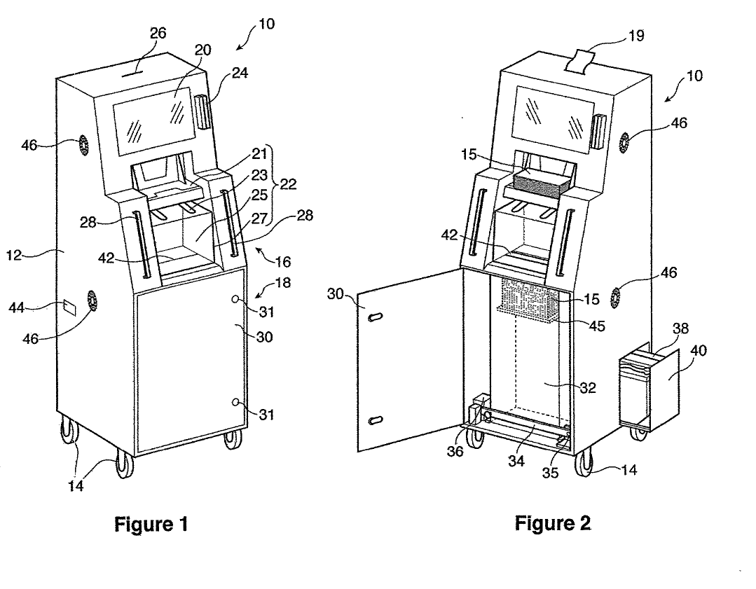

FIGS. 1 and 2 show two perspective views of a preferred embodiment of an apparatus comprising the currency receiving device according to the present invention. The two views are similar, with FIG. 1 showing a front and right side of the device and FIG. 2 showing a front and left side of the device. Another distinction between the views is that FIG. 2 additionally shows a front cabinet door and a side cabinet open, as more particularly described below.

The apparatus is generally indicated with reference numeral 10, and comprises a body 12 mounted on a set of wheels 14. The body 12 houses a variety of elements, some of which are visible, in whole or in part, in the external perspective views of FIGS. 1 and 2. The body 12 may be conveniently viewed as comprising an upper body 16 and a lower body 18.

As shown in FIGS. 1 and 2, the upper body 16 contains a display screen 20, a currency counter 22, a card-reader 24, a print receipt slot 26, and handles 28. The display screen 20 and print receipt slot 26 are backed by a computer and a receipt printer respectively that are not shown in FIGS. 1 and 2 as they are located inside the body 12. Generally, the elements in the upper body 16 provide functions that enable the device to interact with a user. Accordingly, these elements, and particularly the computer or display screen 20 and currency counter22 together, may also be designated as a currency input controller. The currency counter 22 in particular further comprises a hopper 21, reject tray 23, and escrow bin 25. The escrow bin 25 is covered by a retractable cover or escrow door 27. Not shown are escrow-locks that selectively lock or unlock the escrow door 27.

The lower body 18 has a cabinet door 30, shown in FIG. 1 in a closed position. In FIG. 2, the cabinet door 30 is shown in an open position, which reveals a portion of the interior of the lower body 18. From this view it can be seen that the lower body 18 houses a currency receptacle or canister 32, a locking lever 34, and a solenoid-sensor 36. The solenoid-sensor 36 is sized and shaped to accept one end of the locking lever 34. The other end of the locking lever 34 is hinged about an axis 35, so that the opposite end may be selectively lowered or raised, and thereby respectively placed within or removed from contact with the solenoid-sensor 36. The view of the left side of the device shown in FIG. 2 also shows a battery 38 housed in a side cabinet 40. The side cabinet 40 is slidable to permit convenient access to the battery 38. In FIG. 2 the side cabinet 40 is shown partially slid open to reveal the battery 38 contained inside.

It may be noted that the escrow bin 25 has a bottom or base located on a surface that is essentially a junction between the upper body 16 and lower body 18. There is a retractable opening or transfer slot 42 located on this surface. FIG. 1 shows the transfer slot 42 in a closed position, and FIG. 2 shows the transfer slot 42 in at least a partially open position. As will be discussed in greater detail, the apparatus 10 functions to receive currency from a user, and stores said currency in the canister 32. When the transfer slot 42 is open, currency resting on the bottom or base surface of the escrow bin 25 will be transferred to the canister 32. The opening or closing of the transfer slot 42 is controlled by a top plate, described further below.

Continuing with the description of the elements comprising the apparatus or currency receiving device 10, there is an electrical receptacle 44 and a series of air vents 46 shown in FIGS. 1 and 2. In the back of the device, not shown, is an on/off switch and external communications jack. Inside the body 12, also not shown, are a charger, an inverter, an electric motor, and an electrical box. These are in addition to the computer and receipt printer, described earlier as being located inside the body 12. The charger is a device that accepts alternating current electrical power and outputs direct current electrical power. The charger is operatively connected between the electrical receptacle 44 and the battery 38. The battery connects to the inverter, which is a device that converts direct current electrical power to alternating current electrical power. The electrical box is a customized electronic board that receives input power from the battery and the inverter, and outputs power to the electrical motor, computer, display screen, currency counter, receipt printer, and any other electrical components that may require power. The electrical box also receives and provides digital instructions through its connection with the computer.

It can be appreciated that the various elements may be arranged in other configurations. For example, the print receipt slot 26 may be positioned on a side surface rather than a top surface of the device 10. Similarly, the electrical receptacle 44, on/off switch, and communications jack may be placed on any of the side, front, or rear surfaces of the device 10, or the side cabinet 40 may be positioned to slide out from a a different side surface.

The individual elements of the apparatus 10 may now be described in greater detail. The computer or display screen 20 is preferably based on a standard personal computer running an industry standard operating system. The computer or display screen 20 is preferably a reduced size “OEM” version containing only the hardware elements necessary for the currency receiving device, to more conveniently fit within the body 12. Further, a touchscreen type display screen 20 is preferred to reduce the need for a keyboard or other input device, and to simplify user interaction. It has been found that an 800×600 dot per inch liquid crystal display (LCD) screen with passive resistance touch screen has produced adequate results. The computer should preferably have a fixed disk drive or other form of permanent memory to store operating system and application software, as well as external communication ports to interact with the electronic box, other electronic elements of the apparatus 10, and the outside world.

The currency counter 22 may also be a standard device recognized by those skilled in the art. It has been found that a currency counter manufactured by the Glory Company of Japan, which uses a roller friction feed system, has a count speed of 1000 notes per minute and can receive 200 notes at a time produces adequate results. It can be appreciated that other currency recognition units or counters produced by other companies or customized for the apparatus 10 may also be used and produce adequate results. It may be noted that the above-described currency counter required some customization in order to be integrated into the apparatus 10. This included development of a customized electronic interface board and the escrow door 27, neither of which were part of the original off-the-shelf device.

Further standard components include the card-reader 24, receipt printer, and battery 38. A card-reader 24 that accepts 0.007 to 0.033 inch thick plastic or paper cards without mechanical adjustment, including “smart” cards with an embedded chip, and that has an LED display and/or beeper to indicate acceptance is generally adequate. A receipt printer that is compact, lightweight, and quiet, such as the type that prints on a roll of thermal paper has produced adequate results. The receipt printer is positioned so that as the receipt is printed, the paper advances out of the print receipt slot 26, where it can be torn off by the user. This may be seen in FIG. 2, which shows a printed receipt 19 extending out of the print receipt slot 26. The battery 38 is a standard 24 volt direct current type.

The body 12 is sized and shaped so that the apparatus 10 can be moveable by a person. The body 12 is preferably constructed of carbon steel. This material is advantageous because it is strong enough to provide security for the cash contents, yet relatively lightweight to facilitate moveability. The wheels 14 attached to a base of the body support the body 12 above the ground, and enable the apparatus to be rolled along the ground. A person may therefore move the apparatus 10 by pushing or pulling the apparatus, generally through gripping of the handles 28.

The preferred embodiment of the apparatus 10 is about 16 inches wide, 23 inches deep in the lower body 18, and 52 ¾ inches high. The 16 inch width is sufficiently narrow so that a person could grasp both handles 28 with both hands, making the apparatus easier to move. Further, this width is sufficiently narrow so that the apparatus 10 can be moved within the aisle beside a checkout counter of a retail store, such as a supermarket. Such aisles may vary in size from store to store, but are generally wide enough to at least accommodate commonly-used wheeled shopping carts. Accordingly, the apparatus 10 of the present invention, in its preferred embodiment, should be useable in most retail store checkout environments.

The height of the preferred embodiment, at about 52 ¾ inches or 4 feet, 4 ¾ inches, is adapted to be convenient for most users. As will be shown, a user will typically interact with the apparatus 10 by swiping a card through the card-reader 24, placing currency on the hopper 21, possibly removing the currency from the escrow bin 25, and receiving and delivering instructions by reading from and touching the display screen 20. The escrow bin is at about the midpoint of the apparatus height, or at about 2 feet, 2 inches, and the display screen 20 and card-reader 24 are near the top, at about 4 feet high. These figures suggest that the various functions of the apparatus 10 will be readily accessible and comfortable to use for most people, who will typically have a height of between 5 feet and 6 or 6 ½ feet.

The depth of the apparatus 10, at about 23 inches or less than 2 feet, is sufficiently narrow to suggest that the apparatus 10 should be readily moveable without being awkward or unwieldy. When supported by the wheels 14, the apparatus 10 should be readily moveable along a ground surface by a person of average strength.

It can be appreciated that the various dimensions and weight of the preferred embodiment may be modified as appropriate to accommodate different situations. In particular, it is believed that the weight of the apparatus may be further reduced by further further adapting the constituent elements of the apparatus, as described further below. However, it is also believed that the preferred embodiment should be suitable for most situations.

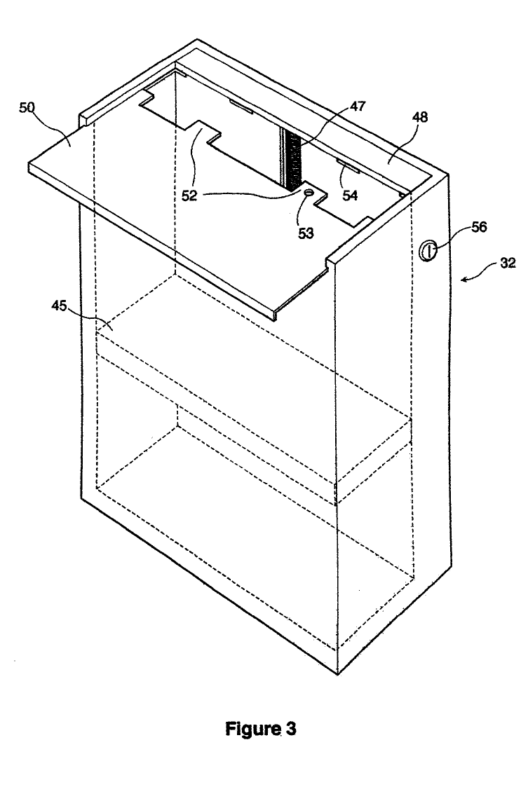

The currency receptacle or canister 32 is similar to the canister disclosed in U.S. Pat. 5,538,122. As shown in FIG. 3, the canister 32 is a rectangular shaped enclosure, accessible only from the top, having a platform 45 to hold currency notes. The platform 45 is driven by a worm-type gear drive or shaft 47, which is driven by the electric motor, located in the body 12, referred to earlier. The shaft 47 occupies a generally hollowed-out section 48 that runs along a back wall of the canister 32. There is a lid 50 having tabs 52 that engage slots 54 in the hollowed-out section 48. There is also a lock 56. As with the previous device the lid is locked by sliding the lid so that the tabs 52 engage the slots 54. When the lock 56 is turned with a key, a pin in the hollowed-out section 48 engages a hole in the tabs 52, not shown. This interaction is picked up by a sensor in the apparatus 10, which informs the apparatus 10 that the canister lid is on and locked. Similarly, the apparatus 10 is informed when the lid is unlocked and removed or available to be removed.

While similar in the above respects, the canister 32 of the present invention however has been further adapted for the apparatus 10 of the present invention by being made to occupy a different set of dimensions. The canister 32 is approximately 8 ¾ inches wide, 5 ¾ inches deep, and 20 ½ inches high, whereas the canister of the prior art is approximately 8 inches wide, 5 inches deep, and 30 inches high. Primarily, the difference is that the canister of the present invention is significantly shorter than the prior art. As noted in FIGS. 1-2, the canister 32 sits underneath the currency counter 22, which is under the display screen 20. By making the canister 32 shorter, the currency input controller, i.e. the display screen 20, hopper 21, and escrow bin 25 in the preferred embodiment are set to a height that is more convenient and accessible to a wide range of users. A further advantage is that the shorter canister itself is somewhat lighter, both when empty and when full, so that when used with the apparatus 10 the apparatus 10 is better adapted to be moved. Yet a further advantage of reducing the canister height is that it adapts the canister so that, when removed from the apparatus 10, it can be placed inside and traverse the “pass through” doors of an armoured vehicle. The pass through doors are typically a pair of doors structured so that when one is open, the other is locked. The doors have a short height, to accept containers of money, such as bags, but at the same time prevent a person from entering. The canister may therefore be passed through the first door. When that door is locked, the second door is unlocked and the canister can be moved to the secure holding area of the armoured vehicle.

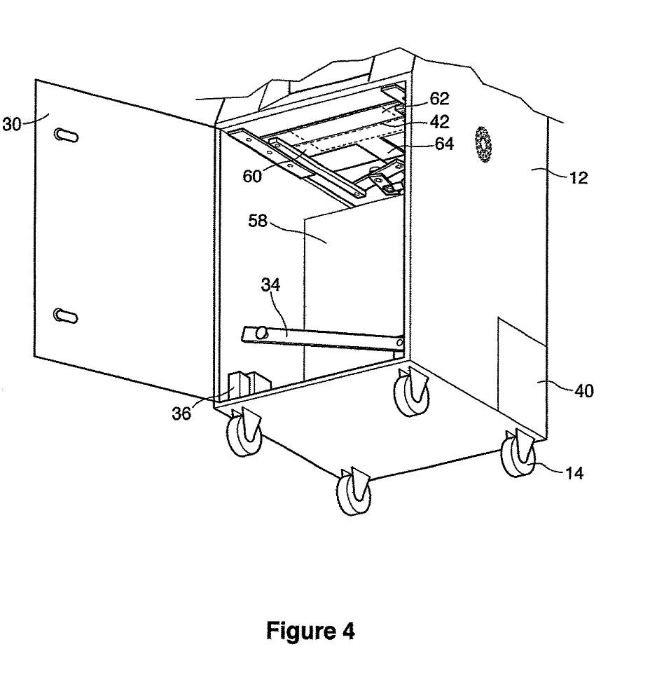

In FIGS. 1 and 2 above a retractable opening or transfer slot 42 was shown located at the bottom or base of the escrow bin 25, immediately above the lower body 18. It was described that the transfer slot 42 is controlled, or opened and closed by, a top plate. This element is better viewed in FIG. 4, which shows a perspective view, from underneath, of the lower body 18 with the door 30 open and the canister 32 removed. In this view the wheels 14, locking lever 34, and solenoid-sensor 36 may be seen. Also, the side cabinet 40 is shown, in this case fully inserted so that it is flush with the body 12 and the battery 38 is not visible. This view further shows a back-plate 58, which separates a front section of the interior from a back section. The front section generally holds the canister 32, and the back section holds the battery 38, as well as the charger, inverter, and electric box, not shown.

FIG. 4 also usefully provides a view of a top plate 60, referred to earlier. It may be seen that the top plate 60 is at the top of the lower body 18, which is directly below the base of the escrow bin 25 of the currency counter 22. Transfer slot 42 may also be seen from this angle. For illustration purposes, transfer slot 42 is shown partially open, from which it can be seen that the retractable opening or transfer slot 42 is formed by the extent of separation of two elements of the top plate 60, a front slider 62 and a rear slider 64. It may be seen from FIG. 2, which shows the transfer slot 42 and the canister 32, and from FIG. 4, which shows the top plate 60 in greater detail, that when the canister 32 is installed in the interior portion of the lower body 18, the canister 32 is positioned so that it is directly below the transfer slot 42. It can therefore be appreciated that when the canister 32 is installed, the lid 50 is removed, and the transfer slot 42 is open, that currency notes positioned at the base of the escrow bin 25 will fall onto the platform 45 of the canister 32. Similarly, when the transfer slot 42 is closed, said currency notes will remain at the base of the escrow bin 25, where they may be removed if the escrow door 27 is unlocked. The front slider 62 and rear slider 64 of the top plate 60 slide along a low-friction track, and are movably controlled through an actuator and an associated link mechanism, not shown. The actuator may be a conventional electromechanical device having opposing arms that alternately project outwards or retract inwards in response to an electrical input. The top plate 60 or transfer slot 42 is open when sliders 62 and 64 are separated, so that there is a gap between them.

Similarly, the top plate 60 or transfer slot 42 is closed when sliders 62 and 64 are together and there is no gap between them, as shown in FIG. 1.

The operation of the currency receiving device may now be described. As noted, the present invention is for a device that receives currency notes for deposit and safekeeping, and is particularly configured to receive deposits from a multiple number of users. The device or apparatus 10 has an independent source of power in the form of the battery 38, and a removable canister 32 to hold the currency notes. Accordingly, a preliminary step in using the device is to ascertain the power requirements for the given application, confirm that they are satisfied, and to install a removable canister 32.

If the device is to be used to receive deposits from multiple users at multiple locations, it will most likely need to rely on stored power from the onboard battery. Accordingly, if the battery power level is low it will be desirable to charge it so that it is at or close to full power. To charge the battery, the attending person can use a conventional electrical cord to connect the electrical receptacle 44 to any wall-outlet source of alternating current. The electricity received will pass through the charger and charge 25, up the battery 38 with direct current electricity. The apparatus 10 of the current invention can be fifted with a charger that accepts the U.K. or European 220 volt standard, or the North American 110 volt standard. When the desired charge level is reached the electrical cord may be disconnected, and the device may then be operated on a stand-alone basis. It can be appreciated that the use of a rechargeable battery as a power source is well understood by those skilled in the art, and that improvements in battery technology that result in lighter, higher capacity batteries may be readily incorporated into the present invention.

If the apparatus 10 is to remain stationary or confined to a limited area, the electrical cord may simply remain plugged into the electrical receptacle 44 while the device is in use. In that case, battery charge level will not be a concern.

To install the currency receptacle or canister 32, the lid 50 should be on and locked so that the tabs 52 are fully inserted into the slots 54. The canister 32 should preferably be empty. However, there may be a quantity of currency notes already inside, which might occur for example if the previous day's deposits were low and it is more convenient to re-use the canister 32. In that case this quantity will need to be entered into the computer as part of the set-up process, so that the device will provide the correct count.

Installation of the canister 32 is achieved by opening front door 30, sliding in the upright canister, and lowering the locking lever 34 until it fits into the niche available in the solenoid-sensor 36. Sensors in the apparatus 10 located near the locked lid 50 will detect that the canister is present and locked, and will activate the solenoid-sensor 36 so that the locking lever 34 cannot be removed. The canister 32 will then be locked in place inside the apparatus 10, blocking attempts at unauthorized removal. The open top end of canister 32 will be directly beneath transfer slot 42. At this point, the canister lock 56 may be unlocked, lid 50 removed, and front door 30 closed.

While the apparatus 10 incorporates a number of security features and precautions, such as the locked canister 32 described above, it is still a stand-alone device that when loaded will contain a substantial amount of cash. This will always present a security risk. Accordingly it is expected that the currency receiving device of the present invention, when in use, will always be attended to by designated security personnel or guards. Such individuals will likely be trained in security procedures, and may be armed and bonded as well. They may also work in pairs, which is preferable as it permits one guard to attend to the currency receiving device while the other is free to focus on the surroundings.

It is an advantage of the present invention that access to the currency receptacle or canister 32 is controlled by computer. Accordingly, security may be readily enhanced by predetermining and restricting access to specific individuals or employees of authorized organizations. It is therefore preferable that all potential users, including both security guards as well as cashiers and other customer depositors, be issued with a magnetic strip access card and an associated personal identification (PIN) number. Therefore, as a further preliminary matter, this information will need to be pre-loaded into the computer. This may be accomplished manually, or alternatively by electronically downloading the information through the communications jack at the back of the currency receiving device.

Accordingly, use of the currency receiving device will generally begin by the security guard or guards swiping their card through the card-reader 24, and entering their personal PIN number. The software program may then run an initiation routine, interacting with the guard through the display screen 20. As noted, this screen is preferably a touchscreen, but if not other interface units such as a keyboard may also be used. Under instructions from the program, the guards may install the canister 32 as described above, and perform any other set-up functions as appropriate.

Subsequently, the device is wheeled to a first location, where the cashier swipes his or her card and enters the corresponding PIN number. Upon verifiation by the computer, the user places a bundle of currency notes on the hopper 21. These are counted by the currency counter 22. Rejected notes, if any, are ejected to the reject tray 23. The balance of the currency notes pass through to the escrow bin 25, where they are visible through the transparent escrow door 27. The escrow door is locked, so the currency notes are not accessible to the user. The display screen 20 informs the user of the count, and requests instructions as to whether to proceed with the deposit. If there is a discrepancy between the displayed count and the user's expected figure, the user may elect to retrieve the funds and to perform a re-count. In that case the computer will release the lock on escrow door 27, enabling the user to take the money back. In most cases the user will press the designated spot on the display screen 20 to inform the computer to proceed with the deposit. In that case the top plate 60 will be activated to open transfer slot 42. The currency notes being deposited will then be supported by the platform 45, or more likely by currency notes previously deposited. The platform 45 will then descend, powered by the electric motor, until the top of the currency notes being deposited fall below the top of the canister 32, as detected by optical sensors located on the body 12.

It is an advantage of the present invention that the top plate 60, as described above, opens the transfer slot 42 by expanding the slot or opening from the inside out, with each side moving equidistant and with equal speed. In this way the currency notes being deposited are more likely to be placed flat upon the platform 45, or upon the stack of notes on said platform. This reduces the risk of any of the currency notes tipping to one side where they could miss the platform 45 or cause a jam. The design of the top plate 60 therefore is instrumental in ensuring that the currency deposited in the canister 32 forms a neat, stacked array of all the notes that have been counted. It may also be noted that the top plate 60 of the present invention also represents an improvement that could be applied to the prior art device of U.S. Pat. No. 5,538,122.

Upon depositing the currency, the receipt printer will print a receipt which appears through and may be torn off from the print receipt slot 26. The receipt contains a printed record of the total deposit, and a breakdown of the number of bills of each denomination in the bundle deposited. The receipt will be kept by the cashier, and may be placed in the cash register for later balancing with the “cash-in-till” figure recorded by the machine.

The above process may then be repeated at further cashier stations or locations. The attending security guards will move the currency receiving device to the next location, receive the deposit, and issue a receipt. When all the locations have been visited, or when the canister 32 is full, the device will be returned to a main cash or security room. There the guards may connect the communications jack and upload the cash deposit information to the customer's computer or, if arrangements have been made, with the computer of the customer's bank. In this way, the cash figures can become instantly integrated with the financial operations of the customer.

The security guards may then begin the procedure of removing the canister 32 from the unit. Upon notifying the device and receiving clearance to proceed, through the touchscreen display, the guards will unlock the front door 30, slide the lid 50 onto the canister 32, and lock the lid by turning the key of the canister lock 56. Similar to the installation procedure, the apparatus sensors will detect that the lid 50 is on and locked. The solenoid-sensor 36 will then be unlocked by the software, enabling the guards to raise the locking lever 34 to its vertical rest position. The canister 32 may then be removed.

Generally, the canister 32 will be taken to an armoured vehicle which will transport it, along with canister or bag pickups from other locations, to the customer's bank, where it can be counted and redistributed. It is an advantage of the present invention that the canister is sized and shaped to be small enough to proceed through the “pass through” doors of an armoured vehicle. Therefore, the canister 32 of the present invention can be readily incorporated into current systems of cash pickup and deposit, in which bags of cash are picked up and placed in armoured vehicles by means of the pass through doors. Further, the canister 32 of the present invention has an advantage in that it does not need to be counted when delivered to the bank. Rather, in most cases it can proceed directly to the sorting facility, which sorts the bills for redistribution. This represents yet another way that the present invention makes cash available more quickly for the customer, which saves money for the customer.

The currency receiving device and method of the present invention has application in many high cash environments. Most typically, this includes large single vendor retail outlets such as supermarkets, since those establishments often have many cashiers and checkout counters, and do a large volume of cash business. In such outlets there will likely be a main security or cash room where the currency receiving device will be stored. The device will likely be operated by in-house security personnel or armoured vehicle security guards who service the store as part of their regular pickup schedule. In these cases the cashiers are all employees of a single store, and the cash collected belongs to the store and is ultimately deposited into the store's bank account.

The cash receiving device may also be useful in multi-vendor outlets such as shopping malls, trade shows, flea markets, or other fairs. These outlets are all distinguished in having a multiple number of generally small, unrelated vendors. While an individual outlet may be small, the group as a whole may represent a substantial amount of cash. Unlike the large single vendor situation, smaller vendors do not have the benefit of being in a large store which can have a secure cash room, with dedicated security personnel and established procedures. Rather they occupy a smaller unit, which may even be just a kiosk or table. Staff may be minimal, even one person, so they are easier to rob during or after hours. Further, some events like trade shows may be spread over a large area, or could take place at night, which are further risk factors. Accordingly, vendors in multi-vendor environments are even more vulnerable and have a stronger need to be able to make regular and secure cash deposits.

The currency receiving device of the present invention is particularly well suited to the needs of multi-vendor environments. As before, a guard could wheel the device from location to location, collecting deposits into the canister 32. It is an advantage of the present invention that each vendor could be issued a receipt, so that when the cash is deposited it will be easy to attribute the proper amount to each vendor. Use of the present invention saves the guards from having to use a separate bag for each vendor, which could become awkward and unwieldy, and might necessitate several trips to the armoured vehicle.

Yet a further benefit is suggested by the fact that the communication means in the device could be made wireless. In that case, each depositor's access card could in effect become an ordinary debit card, and the currrency receiving device could essentially become a mobile automatic teller machine (ATM). Therefore, the cash deposited could be recorded and transmitted by wireless means to the user's bank where it could be credited instantly. Thus use of the currency receiving device could relieve much of the security concerns experienced by smaller vendors in multi-vendor environments. As well, by relieving the vendor of the necessity to go to the bank for at least some of their deposits, there is an economic benefit to the vendor.

It can now be appreciated how the currency receiving device and method of the present invention addresses some of the problems associated with commonly used cash collection methods. The device of the present invention enables users to make accurate, known, cash deposits without leaving their store or checkout counter. Since there is an accurate record, the user is relieved of the worry of a later inaccurate count, which would have to be balanced. The user, who is not trained in security, would not be placed in the uncomfortable position of transporting cash. The user is still free to reject the deposit and retrieve the cash if he or she is uncertain of the device's accuracy.

The security personnel who collect the cash are relieved of the burden and awkwardness of having to carry a multiplicity of bags. All the cash is collected in one secure place, yet there is still individual accountability. Since the money does not have to be counted, there is faster turnaround and the money becomes available to the owner sooner, which saves the owner money. Further, using communication means, the cash received might even be accepted as a deposit at the time of deposit, or shortly thereafter. Wireless communication might even enable the deposit into the currency receiving device to be recognized as a regular bank deposit.

It will be appreciated by those skilled in the art that the foregoing description was in respect of preferred embodiments and that various alterations and modifications are possible within the broad scope of the appended claims without departing from the spirit of the invention. For example, while reference is made to an inverter to convert direct current power to alternating current power, the inverter may be dispensed with by using only elements that are powered by direct current, for example, using a direct current powered computer and currency counter. Removing the inverter could make room for a second battery. Various other modifications will be apparent to those skilled in the art but are not described in any further detail herein.

I claim:

1. A currency receiving device for receiving currency from a user, comprising:
(a) a body adapted to be moved by a person;
(b) a currency input controller, attached to the body, to receive and count deposits of currency;
(c) a currency receptacle, operatively connected to the currency input controller, to receive currency from the currency input controller and to store said currency; and
(d) a source of power, to provide power to said currency input controller;
wherein, upon receiving a first deposit of currency at a first location, said currency receiving device may be moved to a second location to receive a second deposit of currency at said second location.

2. The currency receiving device according to claim 1, wherein the body has a base and wheels attached to said base to support said body above a ground surface.

3. The currency receiving device according to claim 2, wherein the wheels are lockable casters.

4. The currency receiving device according to claim 1, wherein said body has a width, said width being sufficiently narrow so that said currency receiving device can be moved through a retail store check-out aisle.

5. The currency receiving device according to claim 1, wherein said body has a height, said currency input controller being at a height of between two feet and six feet, so that said user can comfortably interact with said currency input controller.

6. The currency receiving device according to claim 1, further including a handle attached to the body, to facilitate movement of said body.

7. The currency receiving device according to claim 1, wherein said source of power is a battery.

8. The currency receiving device according to claim 7, further including a charger operatively connected to said battery, said charger converting alternating current electrical power received from an external source into direct current electrical power to charge said battery.

9. The currency receiving device according to claim 1, wherein the currency input controller comprises:
a computer, to receive and provide user instructions; and
a currency counter, to count the currency deposited in the currency input controller.

10. The currency receiving device according to claim 9, wherein the currency counter has a first bin, to receive currency deposited by the user, and a second bin, accessible to the user and to the currency receptacle, to hold the deposited currency after said deposited currency has been counted.

11. The currency receiving device according to claim 10, wherein said currency input controller informs said user of the count of currency deposited, and further provides response means accessible by the user.

12. The currency receiving device according to claim 11, wherein said response means is a computer touchscreen.

13. The currency receiving device according to claim 1, wherein said currency receptacle includes a lockable and removable lid.

14. The currency receiving device according to claim 13, further including a canister sensor to sense when said currency receptacle is installed and when said lid is on and locked.

15. The currency receiving device according to claim 14, further including a canister lock to secure and prevent unauthorized removal of said currency receptacle, when said currency receptacle is installed in said currency receiving device.

16. The currency receiving device according to claim 1, wherein said currency receptacle is sized and shaped to fit inside a pass through door of an armoured vehicle.

17. The currency receiving device according to claim 1, wherein said currency receptacle is constructed from lexan.

18. The currency receiving device according to claim 1, wherein said body includes a safe having a lockable access opening, said currency receptacle being housed in said safe.

19. The currency receiving device according to claim 1, further including a printer to print a receipt recording the deposit of currency.

20. The currency receiving device according to claim 1, further including an electronic control box to control said currency input controller and said currency receptacle.

21. The currency receiving device according to claim 20, wherein said source of power provides power to said currency input controller and to said electronic control box.

22. The currency receiving device according to claim 1, further including a communication means for communicating the currency count by telecommunication to a remote processor.

23. A method of depositing currency for safekeeping from multiple locations, said method comprising:
(a) providing a currency receiving device, comprising a body adapted to be moved by a person, a currency input controller attached to said body to receive and count deposits of currency, a currency receptacle operatively connected to the currency input controller, to receive currency from the currency input controller and to store said currency, and a source of power, to provide power to said currency input controller;
(b) moving said currency receiving device to a first location;
(c) receiving a deposit of currency at said first location;
(d) providing a deposit verification record; and
(e) repeating said steps (b), (c), and (d) by moving said currency receiving device to at least one further location and receiving at least one further deposit of currency into the currency receiving device.

24. A method of depositing currency for safekeeping from multiple locations according to claim 23, wherein said currency receiving device further includes a printer, said method further including the steps of:
(a) counting the currency deposited by a user;
(b) communicating the currency count to said user;
(c) accepting an instruction from said user as to whether to proceed with the deposit;
(d) returning said currency to said user if said user provides an instruction not to proceed with the deposit in step (d) above; and
(e) transferring said currency to said currency receptacle and printing a receipt for said user if said user provides an instruction to proceed with the deposit in step (d) above.

25. A method of depositing currency for safekeeping from multiple locations according to claim 23, wherein said currency receiving device further includes a communication means, said method further including the steps of:
(a) maintaining a count of the currency deposited; and
(b) upon receiving said deposits of currency from said multiple locations, communicating said count by said communication means to a remote processor.

26. A method of depositing currency for safekeeping from multiple locations according to claim 25, wherein said currency is owned by an owner, said owner having an account at a financial institution, said remote processor being associated with said financial institution, and wherein said count of currency is credited to the account of said owner at said financial institution upon communication of said count by said communication means.

27. A method of depositing currency for safekeeping from multiple locations according to claim 23, wherein said currency receiving device further includes a communication means, each location receiving a deposit of currency from a user, each user having an account at a financial institution, said method further including the steps of:
(a) communicating the count of said deposit of currency to said financial institution of said user by said communication means;
wherein said count of currency is credited to the account of said owner at said financial institution.

28. A method of depositing currency for safekeeping from multiple locations according to claim 27, wherein said communication means is wireless.

29. A method of depositing currency for safekeeping from multiple locations according to claim 23, wherein said body has a base and wheels attached to said base to support said body above a ground surface, said step of moving said currency receiving device further comprising:
(a) pushing or pulling said currency receiving device along a ground surface.

30. A method of depositing currency for safekeeping from multiple locations according to claim 23, wherein said source of power is a battery, and wherein said currency receiving device further includes a charger operatively connected to said battery, for converting alternating current electrical power into direct current electrical power, said direct current electrical power being stored in said battery, said method further including the steps of:
(a) connecting said charger to an external source of alternating current electrical power, thereby increasing the electrical power stored in said battery; and
(b) applying said electrical power stored in said battery to power said currency input controller.

31. A method of depositing currency for safekeeping from multiple locations according to claim 23, wherein said first location and further locations are checkout counters in a retail operation.

32. A method of depositing currency for safekeeping from multiple locations according to claim 23, wherein said currency is owned by an owner, said owner having an account at a financial institution, said method further including the steps of:
(a) removing said currency receptacle from said currency receiving device;
(b) transporting said currency receptacle to said financial institution;
(c) crediting the account of said owner at said financial institution with said count of said currency;
(d) removing said currency from said currency receptacle so that said currency receptacle is empty; and
(e) providing said owner with said currency receptacle or with another empty currency receptacle.
